(19) United States
(12) Patent Application Publication
(10) Pub. No.: US 2021/0219658 A1
(43) Pub. Date: Jul. 22, 2021

(54) FOXING TAPE AND METHODS OF USING FOXING TAPE

(71) Applicant: CONVERSE INC., Boston, MA (US)

(72) Inventors: Xiangming WU, Zhuhai (CN); Renbin FU, Zhongshan (CN); Hongming SHAN, Zhongshan (CN)

(21) Appl. No.: 15/734,878

(22) PCT Filed: Jun. 4, 2019
(86) PCT No.: PCT/CN2019/089978

§ 371 Date: Dec. 3, 2020

(30) Foreign Application Priority Data
Jun. 4, 2018 (CN) 201810562947.X

(51) Int. Cl. A43B 13/32; C09J 7/24; C09J 7/30; C09J 107/00

(52) U.S. Cl. CPC A43B 13/32; C09J 7/241; C09J 7/30; C09J 2409/00; C09J 2407/00; C09J 2407/006; C09J 107/00

(57) ABSTRACT

An uncured or partially cured foxing tape (10) comprises: a two-layer structure of a base foxing tape (11) and an uncrosslinked or partially crosslinked adhesive (12), wherein the base foxing tape (11) comprises an uncured or partially cured rubber, wherein the base foxing tape (11) has a first side and a second side opposite the first side, wherein the uncrosslinked or partially crosslinked adhesive (12) is in contact with the uncured or partially cured rubber on the second side of the base foxing tape (11), wherein the uncrosslinked or partially crosslinked adhesive (12) comprises: an uncured or partially cured rubber; a tackifying resin; and a filler.

### CROSS-REFERENCE TO RELATED APPLICATIONS

This application claims priority to co-pending CN Patent Application entitled “A vulcanized shoe foxing strip, its production method and application,” filed on Jun. 4, 2018, and assigned application number CN201810562947.X, which is incorporated herein by reference in its entirety.

### BACKGROUND

In the traditional manufacturing process of cured rubber articles of footwear, two individuals are needed to complete the attachment of a foxing tape to the upper member and sole structure. In particular, the foxing tape has to be cleaned and/or primed using a treating agent and then dried. Subsequently an adhesive is applied to both the foxing tape and the sole and/or upper, and the adhesive is dried prior to bonding the foxing tape with the upper member and sole structure of the article of footwear. An additional concern is that the treating agent and/or the adhesive are solvent-based compositions and emit one or more volatile organic compounds (VOCs) into the air during processing (e.g., drying process). The emitted VOCs results in VOCs in the work environment, which can be unhealthy.

### BRIEF DESCRIPTION OF THE DRAWINGS

FIG. 1 is a schematic diagram of a foxing tape of the present disclosure prior to processing (e.g., curing).

FIG. 2 illustrates a flow chart of a method of production of the foxing tape.

FIG. 3 illustrates a flow chart of the application of the foxing tape.

FIG. 4 illustrates a perspective view of an article of footwear including a cured foxing tape.

### DESCRIPTION

The present disclosure, in general, provides for compositions that can be used as adhesive in articles of footwear, for example in securing uncured rubber components to one another during curing. For example, a foxing tape can be secured to an upper member and a shoe structure (e.g., toe cap, bumper, heel logo, midsole, cup sole, outer sole, or other rubber component in a shoe) of the article of footwear, by crosslinking the composition to the rubber foxing tape, to the rubber shoe structure, or both, during a process which also cures the rubber of the foxing tape, the rubber of the shoe structure, or both. Prior to crosslinking, the composition can include an uncured or partially cured rubber, a filler, and a tackifying resin as well as optionally one or more other components (e.g., a polyether, a rubber curing agent, other fillers, fatty acids, anti-oxidant agent, and anti-fogging agent). The composition is an uncrosslinked or partially crosslinked adhesive configured for bonding to or between uncured or partially cured rubber in a rubber curing process (e.g., vulcanization). Use of the composition in securing the uncured or partially cured component (e.g., foxing tape) to the footwear can simplify the process for making the footwear by removing the need for the cleaning/priming and drying steps in the process, by removing the need to apply adhesive to both the uncured or partially cured component (e.g., foxing tape) and other components of the shoe (e.g., to the upper member, toe cap, bumper, heel logo, cup sole, midsole, outer sole, and the like), for example, allowing a single person to apply the foxing tape to the upper member and/or other rubber components. Additionally, by removing the need to use solvent-based treating agents and by using the adhesive composition described herein which does not emit concerning levels of potentially toxic volatile organic compounds (VOCs), the use of the composition described herein avoids the emission of concerning levels of potentially toxic VOCs. In addition to these, the article of footwear has enhanced durability as compared to current technologies, and while not being limited by theory, it appears the enhanced durability may be due to the relative increase in the amount of rubber present in the composition.

VOCs are organic chemicals that have a high vapor pressure at ordinary room temperature. Their high vapor pressure results from a low boiling temperature, which causes a large number of molecules to evaporate or sublimate and enter the surrounding air. Some VOCs are dangerous to human health or cause harm to the environment. While various governmental bodies have different definitions for what constitutes a VOC, the European Union defines a VOC as “any organic compound having an initial boiling point less than or equal to 250 degrees Celsius (C) measured at a standard atmospheric pressure of 101.3 kPa”. Examples of compounds which result in the emission of VOCs includes alcohols (ethanol, methanol, isopropanol, etc.), chlorofluorocarbons, ethanes, glycol ethers, ketones (acetone, methyl ethyl ketone, etc.), siloxanes, xylenes, benzene, butanal, carbon disulfide, ethyl acetate, formaldehyde, methyl acetate, methylene chloride, perchloroethylene, styrene, tetrahydrofuran, toluene, and the like. Examples of VOCs particularly to be avoided include acetone, benzene, ethanol, ethyl acetate, formaldehyde, isopropanol, methanol, methyl acetate, methylene chloride, methyl ethyl ketone, tetrahydrofuran, and toluene.

In regard to footwear manufacturing, examples of VOCs commonly used include acetone, methyl ethyl ketone, methyl acetate, ethyl acetate, methylene chloride, methyl cyclohexane, n-butyl acetate, methyl methacrylate, and combinations thereof. In regard to traditional cleaning and/or activating an adhesive as known and currently practiced in the art, about 7 grams/pair of shoes of solvent is consumed. Using embodiments of the present disclosure reduces or eliminates a substantial portion of the previously consumed solvents (e.g., eliminating cleaning and/or activating as well as VOCs not present in the adhesive of the present disclosure).

In this regard, in some examples, the uncrosslinked or partially crosslinked adhesive composition is substantially free of VOC-emitting compounds. In another example, the uncrosslinked or partially crosslinked adhesive composition can be disposed on uncured or partially cured rubber components (e.g., foxing tape, toe cap, bumper, heel logo, cup sole, midsole, outsole, and the like) of an article of footwear to secure the uncured or partially cured rubber components to other components, so that the article of footwear can be generated substantially free of VOC-emitting compounds. In other examples, the uncured or partially cured foxing tape (comprising an uncured or partially cured rubber base foxing tape and the uncrosslinked or partially crosslinked adhesive composition) is substantially free of VOC-emitting compounds. In yet other examples, the processes of manufacturing the uncured or partially cured foxing tape is substantially free of the emission of VOCs. In yet other examples, the process of using the uncured or partially cured foxing tape to secure the foxing tape to an upper member or to a shoe structure or both is substantially free of the emission of VOCs. In one example, the uncured or partially cured foxing tape of the present disclosure is substantially free of, and does not emit any organic compound having an initial boiling point less than or equal to 250 degrees C. measured at a standard atmospheric pressure of 101.3 kPa during use in the manufacture of articles of footwear as described herein. In another example, the uncured or partially cured foxing tape of the present disclosure is substantially free of and does not emit acetone, methyl ethyl ketone, methyl acetate, ethyl acetate, methylene chloride, methyl cyclohexane, n-butyl acetate, methyl methacrylate, and combinations thereof during use in the manufacture of articles of footwear as described herein.

While in some examples the composition is a solid at temperatures below about 55 degrees Celsius, the composition may phase change into a liquid or semi-solid at temperatures above about 55 to 60 degrees C., or may become increasingly tacky when heated to temperatures above about 55 to 60 degrees C., which allows for the composition to be stored and then activated by increasing the temperature as opposed to being primed (e.g., use of a solvent to activate) or applied “wet” and dried immediately before adhering the uncured or partially cured rubber component to other components (e.g., foxing tape to the upper member and other components). Thus, use of the compositions described herein can result in few if any VOCs being emitted during use of the compositions (e.g., at least 50 weight percent fewer, at least 75 weight percent fewer, at least 90 weight percent fewer, or at least 90 weight percent fewer) than traditional solvent-based treating agents and/or adhesive systems used for similar purposes. Additionally, the use of the compositions described herein also provide the required bonding performance in articles of footwear.

The adhesive (e.g., the composition) can be disposed on one or more surfaces of uncured or partially cured rubber components (e.g., foxing tape, toe cap, bumper, heel logo, cup sole, midsole, outsole, and the like) used to form an article of footwear. An example of how this can be accomplished is illustrated using foxing tape, but the adhesive can be applied to all other uncured or partially cured rubber components used to form a shoe and the foxing tape example is merely an illustration and can be applied to other uncured or partially cured rubber components of the article of footwear.

The uncured or partially cured foxing tape can be formed by first mixing components to form the adhesive (e.g., the composition). Subsequently, the uncrosslinked or partially crosslinked adhesive material can be applied to a base foxing tape material, forming a foxing tape having a two layer structure (e.g., adhesive and base foxing tape). For example, the uncrosslinked or partially crosslinked adhesive can be coextruded with the rubber composition forming the base foxing tape to form the uncured or partially cured foxing tape having a two layer structure, where the first layer is a base foxing tape and the second layer is an uncrosslinked or partially crosslinked adhesive and the first layer and second layer are disposed adjacent one another.

As noted above, the composition can be used in foxing tape. For uncured or partially cured foxing tape, the tape has a two-layer structure of a base foxing tape and an uncrosslinked or partially crosslinked adhesive (e.g., composition). The base foxing tape comprises an uncured or partially cured rubber and has a first side and a second side opposite the first side. The uncrosslinked or partially crosslinked adhesive is in contact with the uncured or partially cured rubber on the second side of the base foxing tape. After formation and prior to use, the uncured or partially cured foxing tape can include a release material (film or a textile) on the first side and/or the second side of the uncured or partially cured foxing tape so that the tape can be stacked and stored.

For other uncured or partially cured rubber components (e.g., toe cap, bumper, heel logo, cup sole, midsole, outer sole, and the like), the adhesive composition can be disposed on the component by applying with a device such as a brush, spraying, pouring, or otherwise placing onto the surface of the uncured or partially cured rubber component. The uncured or partially cured rubber component with the adhesive composition disposed on it can have a similar two-layer structure as the foxing tape.

As the uncured or partially cured foxing tape includes the adhesive composition comprising a tackifying resin, during processing, the tackifying resin can serve to hold the foxing tape in place on the upper member and/or shoe structure (e.g., toe cap, bumper, heel logo, cup sole, midsole, outer sole, and the like) until bonding is achieved. Due to the presence of the uncured or partially cured rubber and the rubber curing package in the adhesive composition, exposing the uncured or partially cured foxing tape to processing conditions sufficient to cure the rubber of the foxing tape and/or the shoe structure results in the rubber of the adhesive crosslinking to itself, crosslinking to the rubber of the foxing tape, crosslinking to the rubber of the shoe structure, or any combination thereof, forming a bond of sufficient strength to withstand the wear and tear to which articles of footwear are commonly exposed.

After processing (e.g., activation and curing), a cured rubber foxing tape is formed from the uncured or partially cured foxing tape. The cured rubber foxing tape has a two-layer structure of the base foxing tape and a crosslinked adhesive layer, where the base foxing tape and the crosslinked adhesive layer are bonded to one another. After curing, the base foxing tape comprises a cured rubber, where the crosslinked adhesive is in contact (e.g., bonded) with the cured rubber on the second side of the base foxing tape.

In regard to use of the uncrosslinked or partially crosslinked foxing tape in making articles of footwear, the uncured or partially cured foxing tape can be disposed on a junction on the outer edge perimeter between an upper member and an uncured or partially cured shoe structure of an article of footwear. The uncrosslinked or partially crosslinked foxing tape can extend substantially around the entire perimeter of the article of footwear. In the alternative, one or more pieces of uncrosslinked or partially crosslinked foxing tape can extend around a portion (e.g., heel region, toe region) of the article of footwear. Prior to or simultaneously with disposing the uncured or partially cured foxing tape to the junction, the uncured or partially cured foxing tape is activated by heating to about 55 to 60 degrees Celsius or more. In some examples, heating results in the adhesive layer softening or becoming a liquid or semisolid layer or becoming increasingly tacky. The uncrosslinked or partially crosslinked foxing tape can be attached to the upper member and held in place by the adhesive until curing. For example, the uncrosslinked or partially crosslinked foxing tape can be attached to the upper member and/or the uncured or partially cured shoe structure along the joint during a curing process (e.g., vulcanization process). Once the curing process is complete, the upper member and the cured shoe structure are secured to one another, at least in part, by the cured foxing tape. Similarly, other uncured or partially cured rubber components (e.g., toe cap, bumper, heel logo, cup sole, midsole, outer sole, and the like) can be attached to one or components of the article of footwear to secure them during the curing process.

The present disclosure provides for an uncured or partially cured foxing tape, comprising: a two-layer structure of a base foxing tape and an uncrosslinked or partially crosslinked adhesive, wherein the base foxing tape comprises an uncured or partially cured rubber, wherein the uncured or partially cured foxing tape has a first side and a second side opposite the first side, wherein the uncrosslinked or partially crosslinked adhesive is in contact with the uncured or partially cured rubber on the second side of the uncured or partially cured foxing tape, wherein the uncrosslinked or partially crosslinked adhesive comprises: an uncured or partially cured rubber; a tackifying resin; and a filler.

As compared to conventional adhesive compositions used in footwear manufacturing, examples of the adhesive composition of the present disclosure can have a higher concentration of uncured or partially cured rubber. This high concentration of uncured or partially cured rubber allows the adhesive composition to crosslink with the uncured or partially cured rubber of the base foxing tape, the shoe structure, or both, and form a secure, flexible bond to one or both of these components when the uncured or partially cured foxing tape is used in footwear manufacturing. The high concentration of uncured or partially cured rubber also increases the flexibility of the adhesive composition itself once it is crosslinked. In one example, the adhesive composition can comprise at least 40 weight percent of the uncured or partially cured rubber. The adhesive composition can comprise from about 40 weight percent to about 80 weight percent of the uncured or partially cured rubber. The adhesive composition can comprise from about 40 weight percent to about 70 weight percent of the uncured or partially cured rubber. The adhesive composition can comprise from about 40 weight percent to about 64 weight percent of the uncured or partially cured rubber.

As compared to conventional adhesive compositions used in footwear manufacturing, examples of the adhesive composition of the present disclosure can have a higher concentration of tackifying resin. The high concentration of the tackifying resin allows the adhesive composition to adhere well to the base foxing tape or the shoe structure or both during the manufacturing process, and to hold the components together before the adhesive composition and the rubber components are fully cured. The adhesive composition can comprise at least 5 weight percent of the tackifying resin. The adhesive can comprise from about 5 weight percent to about 15 weight percent of the tackifying resin. The adhesive can comprise about 8 weight percent to about 12 weight percent of the tackifying resin. In one aspect, the tackifying resin can comprise a C3-C9 petroleum resin or a terpene phenolic resin or both. In another aspect, the tackifying resin can comprise or consist essentially of a C5 petroleum resin. The tackifying resin can comprise or consist essentially of a C9 petroleum resin. The tackifying resin can comprise or consist essentially of a terpene phenolic resin.

Examples of the adhesive composition of the present disclosure can include high concentrations of both the uncured or partially cured rubber and the tackifying resin. For example, the ratio of the weight percent of uncured or partially cured rubber to the weight percent of the tackifying agent present in the adhesive composition can be at least 3:1. In one aspect, the ratio can be about 3:1 to 5:1. In another aspect, the ration can be at least 4:1.

In addition to the uncured or partially cured rubber and the tackifying resin, the adhesive composition optionally can comprise a filler. When the filler is present, the adhesive composition can comprise at least 10 weight percent of the filler. The adhesive composition can comprise at least 20 weight percent of the filler. The adhesive composition can comprise from about 10 weight percent to about 50 weight percent of the filler. The adhesive composition can comprise from about 20 to about 44 weight percent of the filler.

The ratio of the weight percent of the uncured or partially cured rubber to the weight percent of the filler can be at least 1.5:1, or can be about 1.5:1 to 2.5:1, or can be about 1.5:1 to about 2:1. The ratio of the weight percent of the filler to the weight percent of the tackifying agent in the adhesive composition can be at least 1.5:1, or can be about 1.5:1 to 2.5:1, or can be about 1.5:1 to about 2:1.

The weight percent for components of the uncrossliked or partially crosslinked adhesive can be as follows: about 40 to 64 weight percent of the uncured or partially cured rubber, about 8 to 12 weight percent of the tackifying resin, about 20 to 44 weight percent of the filler and 0 to 15 weight percent of one or more additional components. The composition is substantially free of organic compounds that become volatilized when heated to a temperature of 60 degrees Celsius or above at about 1 ATM, where the organic compounds comprise acetone, methyl ethyl ketone, ethyl acetate, or a combination thereof.

The present disclosure provides for a method of making an article of footwear, comprising: activating the uncured or partially cured foxing tape, wherein the uncured or partially cured foxing tape is a two-layer structure of a base foxing tape and an uncrosslinked or partially crosslinked adhesive, wherein the base foxing tape comprises an uncured or partially cured rubber, wherein the uncured or partially cured foxing tape has a first side and a second side opposite the first side, wherein the uncrosslinked or partially crosslinked adhesive is in contact with the uncured or partially cured rubber on the second side of the uncured or partially cured foxing tape, wherein the uncrosslinked or partially crosslinked adhesive comprises: an uncured or partially cured rubber; a tackifying resin; and a filler; disposing, at a junction at the point of contact between an upper member and an uncured or partially cured shoe structure, the uncured or partially cured foxing tape on a first part of the perimeter of the footwear on the junction so that the uncured or partially cured foxing tape is disposed on a first part of the upper member and on a first part of the uncured or partially cured shoe structure along the junction, wherein a portion of the uncured or partially cured foxing tape comprising the adhesive is adjacent a first part of the upper member, a first part of the uncured or partially cured shoe structure, and the junction; and curing the article to form a cured rubber shoe including the cured rubber foxing tape and a cured rubber shoe structure, wherein the cured rubber shoe structure and upper member are bonded together at least in part by crosslinks formed between the cured rubber of the foxing tape and the cured rubber of the shoe structure.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure. Any recited method may be carried out in the order of events recited or in any other order that is logically possible.

The present disclosure can employ, unless otherwise indicated, techniques of material science, chemistry, textiles, polymer chemistry, textile chemistry, and the like, which are within the skill of the art. Such techniques are explained fully in the literature.

Unless otherwise defined, all technical and scientific terms used herein have the same meaning as commonly understood by one of ordinary skill in the art of material science, chemistry, textiles, polymer chemistry, textile chemistry, and the like. Although methods and materials similar or equivalent to those described herein can be used in the practice or testing of the present disclosure, suitable methods and materials are described herein.

As used in the specification and the appended claims, the singular forms “a,” “an,” and “the” may include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the term “weight” refers to a mass value, such as having the units of grams, kilograms, and the like. Further, the recitations of numerical ranges by endpoints include the endpoints and all numbers within that numerical range. For example, a concentration ranging from 40 percent by weight to 60 percent by weight includes concentrations of 40 percent by weight, 60 percent by weight, and all water uptake capacities between 40 percent by weight and 60 percent by weight (e.g., 40.1 percent, 41 percent, 45 percent, 50 percent, 52.5 percent, 55 percent, 59 percent, etc.).

As used herein, the term “providing”, such as for “providing a layered material”, when recited in the claims, is not intended to require any particular delivery or receipt of the provided item. Rather, the term “providing” is merely used to recite items that will be referred to in subsequent elements of the claim(s), for purposes of clarity and ease of readability.

As used herein, the terms “at least one” and “one of” more of an element are used interchangeably, and have the same meaning that includes a single element and a plurality of the elements, and may also be represented by the suffix “(s)” at the end of the element. For example, “at least one polyurethane”, “one or more polyurethanes”, and “polyurethane(s)” may be used interchangeably and have the same meaning.

Now having described the present disclosure in general, additional details are provided. Compositions of the present disclosure can be used as an adhesive in articles of footwear. In particular, the adhesive can be used for securing uncured or partially cured rubber components to one another such as foxing tape, a toe cap, a bumper, heel logo, a cup sole, a midsole, an outer sole, and the like. In one example, the adhesive can be used in foxing tape, where the foxing tape can have a two-layer structure of a base foxing tape and the adhesive. Other rubber components can have a two-layer structure as well with the adhesive. Although embodiments are not limited to foxing tape, examples of foxing tape are provided for illustration purposes.

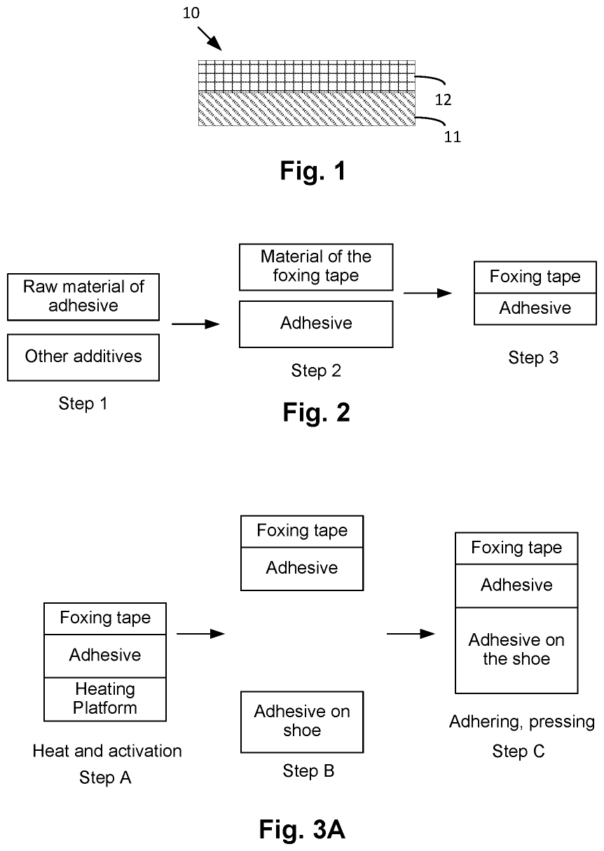

FIG. 1 illustrates a cross-sectional view of the foxing tape 10 of the present disclosure. The foxing tape include the base foxing tape 11 and the adhesive 12. As provided in detail herein, the foxing tape can be formed, activated, disposed on an article of footwear, and cured.

FIG. 2 is a block diagram that illustrates the formation of the uncured or partially cured foxing tape. In step 1, the materials to form the adhesive are mixed. In step 2, the materials of the base foxing tape (e.g., uncured or partially cured rubber material) and the uncrosslinked or partially crosslinked adhesive are contacted with one another to form the uncured or partially cured foxing tape as shown in step 3. In an example, the base foxing tape material and the uncrosslinked or partially crosslinked adhesive can be coextruded to form the uncured or partially cured foxing tape. In another example, the base foxing tape can be made, and the uncrosslinked or partially crosslinked adhesive can be formed into a film and then the film can be applied (e.g., laminated) to the base foxing tape to form the uncured or partially cured foxing tape. In yet another example, the base foxing tape can be made and then the uncrosslinked or partially crosslinked adhesive can be sprayed, printed, or poured to the base foxing tape to form the uncured or partially cured foxing tape.

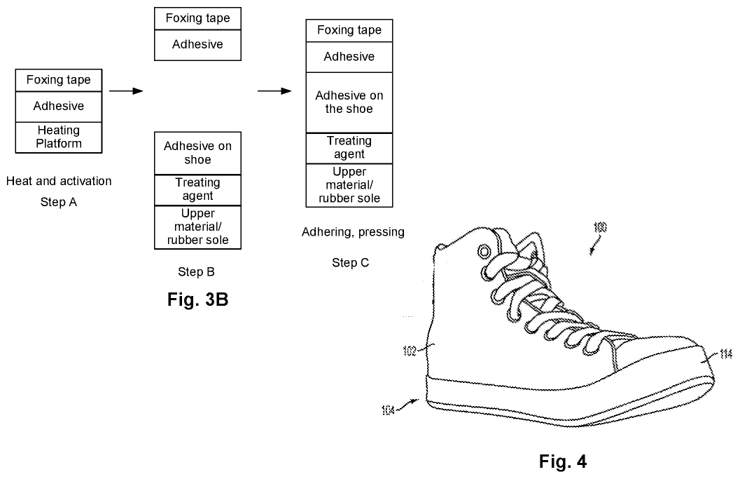

FIG. 3A is a block diagram that illustrates the activation and placement of the uncured or partially cured foxing tape on the article of footwear. In step A, the uncured or partially cured foxing tape is activated (e.g., heated to above 60 degrees Celsius) so that the adhesive becomes softer or increasingly tacky (e.g., so that it becomes sufficiently sticky that it adheres when put in contact with a surface of a material). In step B, the uncured or partially cured foxing tape is disposed on a junction between the upper member and an uncured or partially cured shoe structure. In step C, the uncured or partially cured foxing tape and uncured or partially cured shoe structure are cured to form the article of footwear with the cured foxing tape adhered to the upper member and of the cured shoe structure.

FIG. 3B is a block diagram that illustrates the activation and placement of the uncured or partially cured foxing tape on the article of footwear. In step A, the uncured or partially cured foxing tape is activated (e.g., heated to above 60 degrees Celsius) so that the adhesive becomes softer or increasingly tacky (e.g., so that it becomes sufficiently sticky that it adheres when put in contact). In step B, the uncured or partially cured foxing tape is disposed on a junction between the upper member and uncured or partially cured shoe structure. The uncured or partially cured foxing tape can be disposed onto the adhesive on the footwear and the treating agent. When an additional adhesive is applied to the upper material or the rubber shoe or both before applying the foxing tape, the adhesive applied to the upper material or the rubber shoe or both can be an adhesive composition as described herein. Alternatively, the adhesive composition applied to the upper material or the rubber shoe or both prior to applying the foxing tape can be a conventional adhesive used in footwear manufacturing, such as a water-borne adhesive including one or more organic solvents. In step C, the uncured or partially cured foxing tape and uncured or partially cured shoe structure are cured to form the article of footwear with the cured foxing tape adhered to the upper member and cured shoe structure.

The composition of the adhesive can include the uncured or partially cured rubber, the tackifying resin, and optionally the filler (e.g., silica) as well as one or more other components (e.g., fillers, the polyether, fatty acids, the rubber curing agent, anti-oxidant agent, and anti-fogging agent). The composition is an uncrosslinked or partially crosslinked adhesive that can be applied to the base foxing tape so that the uncured or partially cured foxing tape can bond with uncured or partially cured shoe structure and upper member in a rubber curing process. Typically, disposing a conventional foxing tape to footwear includes multiple individuals and multiple steps, while the present disclosure reduces the number of individuals and/or steps required, thus simplifying the process for making the footwear. Additionally, the composition of the adhesive described herein includes few if any VOCs and/or the step of activating the foxing tape does not require priming with a solvent, so the process of adhering the foxing tape of the present disclosure can be performed with emission of fewer and less harmful VOCs than traditional processes. These advantages can be achieved while maintaining or improving durability.

Notwithstanding the use of the composition in adhesives in foxing tape, the composition (e.g., as an adhesive) can be incorporated into articles such as textiles that incorporate rubber components. For example, the textile can include footwear or components thereof, apparel (e.g., shirts, jerseys, pants, shorts, gloves, glasses, socks, hats, caps, jackets, undergarments) or components thereof, containers (e.g., backpacks, bags), and upholstery for furniture (e.g., chairs, couches, car seats), bed coverings (e.g., sheets, blankets), table coverings, towels, flags, tents, sails, and parachutes. In addition, the composition can be used to produce articles or other items that are disposed on the article, where the article can be striking devices (e.g., bats, rackets, sticks, mallets, golf clubs, paddles, etc.), athletic equipment (e.g., golf bags, baseball and football gloves, soccer ball restriction structures), protective equipment (e.g., pads, helmets, guards, visors, masks, goggles, etc.), locomotive equipment (e.g., bicycles, motorcycles, skateboards, cars, trucks, boats, surfboards, skis, snowboards, etc.), balls or pucks for use in various sports, fishing or hunting equipment, furniture, electronic equipment, construction materials, eyewear, timepieces, jewelry, and the like.

The article of footwear of the present disclosure may be designed for a variety of uses, such as casual use, sporting, athletic, military, work-related, or recreational. The article of footwear can be designed use in outdoor sporting activities, such as global football/soccer, golf, American football, rugby, baseball, running, track and field, cycling (e.g., road cycling and mountain biking), and the like. The article of footwear can optionally include traction elements (e.g., lugs, cleats, studs, and spikes as well as tread patterns) to provide traction on soft and slippery surfaces. Cleats, studs and spikes are commonly included in footwear designed for use in sports such as global football/soccer, golf, American football, rugby, baseball, and the like, which are frequently played on unpaved surfaces. Lugs and/or exaggerated tread patterns are commonly included in footwear including boots design for use under rugged outdoor conditions, such as trail running, hiking, and military use.

FIG. 4 illustrates a perspective view of an article of footwear 100. The footwear includes an upper member 102 and cured sole structure 104 (e.g., one or more rubber components such as midsole, cup sole, outer sole, and similar components), where the cured foxing tape 114 adheres, at least in part, the upper member 102 and the cured sole structure 104. In particular, during manufacturing, the uncured or partially cured foxing tape is disposed on a junction on the outer edge perimeter between the upper member 102 and the uncured or partially cured sole structure of an article of footwear 100. The uncured or partially cured foxing tape can extend substantially around the entire perimeter of the article of footwear 100. In the alternative, one or more pieces of uncured or partially cured foxing tape can extend around a portion (e.g., heel region, toe region) of the article of footwear. The uncured or partially cured foxing tape can be attached to the upper member 102 and the uncured or partially cured sole structure along the joint during a curing process (e.g., vulcanization process). Once the curing process is complete, the upper member 102 and the cured sole structure 104 are secured to one another, at least in part, by the cured foxing tape 114. Although not shown, other rubber components such as toe cap, bumper, midsole, cup sole, heel logo, and the like can be secured to the article of footwear using the adhesive of the present disclosure.

The method of making an article of footwear can include activating the uncured or partially cured foxing tape. The uncured or partially cured foxing tape can be activated by heating the uncured or partially cured foxing tape to about 55 to 60 degrees Celsius for about 2 to 60 minutes. Following activation, the uncured or partially cured foxing tape is disposed at a junction at the point of contact between the upper member and the uncured or partially cured shoe structure. In particular, the uncured or partially cured foxing tape is disposed on a first part of the perimeter of the footwear on the junction so that the uncured or partially cured foxing tape is disposed on a first part of the upper member and on a first part of the uncured or partially cured shoe structure along the junction. Next, the article is cured (e.g., vulcanized) to form the article of footwear including the cured shoe structure and upper member secured together, at least in part by the cured foxing tape. The curing process can include heating the article to about 100 to 140 degrees Celsius, or optionally about 120 degrees Celsius for about 50 to 120 minutes. The activation and curing process can be conducted at about 1 ATM. Similarly, other rubber components using the adhesive can be secured to the shoe in this manner.

Now having described aspects of the present disclosure in general, additional details are be provided for the composition used in the adhesive. The composition is an uncrosslinked or partially crosslinked adhesive configured for bonding to or between uncured or partially cured rubber in a rubber curing process. In one example, the composition is substantially free of VOC-emitting compounds (e.g., substantially free of acetone, methyl ethyl ketone, ethyl acetate and the like). For example, (e.g., at least 50 weight percent fewer, at least 75 weight percent fewer, at least 90 weight percent fewer, at least 99 weight percent fewer) VOCs are released during activation and curing as compared to methods using traditional treating agents or traditional adhesives or both. In some examples, the composition is a solid at temperatures below 55 degrees Celsius and a liquid or semi-solid at temperatures above about 55 to 60 degrees Celsius. In other examples, the adhesive becomes increasingly tacky at temperatures above about 55 to 60 degrees Celsius.

In both examples, as a result of the temperature sensitivity of the adhesive, when foxing tape includes a layer of the uncrosslinked or partially crosslinked adhesive on a base foxing tape, the composite (e.g., uncured or partially cured foxing tape) can be formed and then stored for future use by optionally including a release layer on one or both sides of the composite or separately between layers of composite foxing tape. Then prior to use, the uncured or partially cured foxing tape can be heated (e.g., above 60 degrees Celsius) to activate the uncrosslinked or partially crosslinked adhesive, in contrast to other adhesives that use a solvent and require drying before use. Subsequently, the uncured or partially cured foxing tape with the uncrosslinked or partially crosslinked adhesive is disposed on the article of footwear and then cured to attach the upper member and the shoe structure, in a more convenient process with fewer steps which also produces fewer VOCs than processes using traditional solvent-based treating agents and/or adhesives.

The composition can include the uncured or partially cured rubber, the additive, the tackifying resin, and the rubber curing agent. The optional additional components can include one or more of other fillers, the polyether, the rubber curing agent, fatty acids, anti-oxidant agents, anti-fogging agents, colorants, and the like.

The rubber (e.g., uncured rubber, partially cured rubber, or cured rubber) of the composition, the base foxing tape, the shoe structure, or all of these can include one or more natural and/or synthetic rubbers. The rubbers are elastomeric materials such as a thermoset material or a thermoplastic rubber.

A “thermoset material” is understood to refer to a material which cannot be heated and melted, as its melting temperature is at or above its decomposition temperature. A “thermoset material” refers to a composition which comprises at least one thermoset polymer (e.g., optionally thermoplastic polymers can be included). The thermoset polymer and/or thermoset material can be prepared from a precursor (e.g., an uncured or partially cured polymer or material) using actinic radiation (e.g., thermal energy, ultraviolet radiation, visible radiation, high energy radiation, infrared radiation) to form a partially cured or fully cured polymer or material which no longer remains fully thermoplastic. In some cases, the cured or partially cured elastomeric material may retain some thermoplastic properties, in that it is possible to partially soften and mold the elastomeric material at elevated temperatures and/or pressures, but it is not possible to melt and reform the elastomeric material. The curing can be promoted, for example, with the use of high pressure and/or a catalyst. The curing process is irreversible since it results in crosslinking and/or polymerization reactions of the precursors. The uncured or partially cured elastomeric materials can be malleable or liquid prior to curing. In some cases, the uncured composition or partially cured elastomeric materials can be molded into their final shape. Once hardened, a thermoset material cannot be re-melted in order to be reshaped, but it may be possible to soften it. In contrast, thermoplastic rubbers include both elastomeric and thermoplastic properties and can be repeatedly melted and cooled.

The rubber can be a natural rubber, a polybutadiene rubber, a polyisoprene rubber, or any combination thereof. The rubber can include thermoplastic polyurethane elastomers, thermoplastic polyurea elastomers, thermoplastic polyamide elastomers (PEBA or polyether block polyamides), thermoplastic polyester elastomers, metallocene-catalyzed block copolymers of ethylene and α-olefins, and styrene block copolymer elastomers. The natural or synthetic rubbers can include: butadiene rubber, styrene-butadiene (SBR) rubber, butyl rubber, isoprene rubber, urethane rubber (e.g., millable), nitrile rubber, neoprene rubber, ethylene propylene diene monomer (EPDM) rubber, epichlorohydrin rubber, polyacrylic rubber, polyether block amides, ethylene-vinyl acetate, ethylene-propylene rubber, urethane rubber, or any combination thereof. Other examples of rubber compounds include, but are not limited to polynorbornene rubber, methyl methacrylate butadiene styrene rubber (MBS), styrene ethylene butylene (SEBS) rubber, silicone rubber, and mixtures thereof. Still other examples of rubber compounds can include thermoplastic polyester-polyurethanes, polyether-polyurethanes, polycarbonate-polyurethanes, NYLON 6, NYLON 66, NYLON 610, NYLON 11, NYLON 12, copolymerized NYLON, NYLON MXD6, NYLON 46, HYTREL (available from DuPont), EXACT (available form ExxonMobil), ENGAGE (available from the Dow Chemical Company), poly(styrene-butadiene-styrene), poly(styrene-ethylene-co-butylene-styrene), and poly(styrene-isoprene-styrene).

In an aspect, the rubber is a natural rubber. Each of the uncured or partially cured rubber component(s) (e.g., the uncured or partially cured foxing tape) and the adhesive comprise about 7 or more weight percent natural rubber or about 8 or more weight percent natural rubber. Although not intending to be bound by theory, each component and the adhesive including natural rubber have improved bonding and durability.

In an aspect, the ratio of the natural rubber to the tackifying agent can be about 3:1 to 5:1 or about 4:1. The ratio of the natural rubber to the filler can be about 1.5:1 to 2.5:1 or about 2:1. The ratio of the filler to the tackifying agent can be about 1.5:1 to 2.5:1 or about 2:1.

The rubber can include an additive. For example, the additive can include a plurality of polymer chains individually having a maleic anhydride moiety grafted to the polymer chain. The additive can be a functionalized polymer which has been modified by grafting maleic anhydride groups into the polymer backbone, end groups, or side groups, including ethylene-based polymers with maleic anhydride grafting. The additive can be a maleic-anhydride modified polymer such as “FUSABOND” (sold by E. I. du Pont de Nemours and Company, Wilmington, Del., USA). The functionalized polymer can include modified ethylene acrylate carbon monoxide terpolymers, ethylene vinyl acetates (EVAs), polyethylenes, metallocenepolyethylenes, ethylene propylene rubbers and polypropylenes, where the modification to the functional polymer can include maleic anhydride grafted to the functional polymer. The amount of the additive present in the uncured rubber formulation can be up to 10 parts per hundred resin (phr), or from about 1 phr to about 8 phr, or from about 3 phr to about 6 phr.

The tackifying resin can be a hydrocarbon resin, a terpene resin, or a combination thereof. The hydrocarbon resin can be an aliphatic hydrocarbon resin (e.g., C1 to C9 or C3 to C9), or an aromatic hydrocarbon resin (e.g., C1 to C9 or C3 to C9). The hydrocarbon resin can be an aromatic hydrocarbon resin (e.g., C9 petroleum resin, C8 petroleum resin, C5 petroleum resin). The terpene resin is selected from a terpene phenolic resin, a polyterpene resin, a styrenated terpene resin, or a combination thereof.

The fillers can include silica, carbon black, talc, a calcium component (e.g., calcium component comprises a nano-calcium, a calcium carbonate, or a combination thereof), and a combination thereof. In an aspect, the filler is silica (e.g., having dimensions on the nano to micro scale).

The uncured or partially cured rubber can be at least partially soluble (e.g., about 5 percent or more, about 10 percent or more, about 25 percent or more, about 50 percent or more) in the polyether. The polyether can be a polyalkylene glycol (e.g., C2 to C6) such as polyethylene glycol or a polypropylene glycol (e.g., about 3000 to 6000 Dalton or about 4000 daltons).

The composition can include a fatty acid. The fatty acid can include a saturated fatty acid, such as stearic acid.

The composition can further comprise process oils, an anti-oxidant agent (e.g., styrene phenol), anti-fogging agent (e.g., sorbitan ester), and/or a curing package including at least one of crosslinking agent(s), accelerant(s), and crosslinking retarder(s). Examples of process oils include, but are not limited to, paraffin oil and/or aromatic oils.

The curing package can include crosslinking agents such as a sulfur component (e.g., elemental sulfur or a sulfur containing organic compound (e.g., a monosulfide compound, a disulfide compound, or a polysulfide compound)) or peroxide agents (e.g., di-t-amyl peroxide, di-t-butyl peroxide, t-butyl cumyl peroxide, di-cumyl peroxide (DCP), di(2-methyl-1-phenyl-2-propyl)peroxide, t-butyl 2-methyl-1-phenyl-2-propyl peroxide, di(t-buylperoxy)-diisopropylbenzene, 2,5-dimethyl-2,5-di(t-butylperoxy)hexane, 2,5-dimethyl-2,5-di(t-butylperoxy)hexyne-3,1,1-di(t-butylperoxy)-3,3,5-trimethylcyclohexane, 4,4-di(t-butylperoxy)-n-butylvalerate, and mixtures thereof), or combinations of sulfur component and peroxide agent. In an aspect, the curing package comprises a sulfur component.

The curing package can include accelerates such as N-cyclohexyl-2-benzothiazole sulfenamide (CBZ), N-oxydiethylene-2-benzothiazole sulfenamide, N,N-diisopropyl-2-benzothiazole sulfenamide, 2-mercaptobenzothiazole, 2-(2,4-dinitrophenyl)mercaptobenzothiazole, 2-(2,6-diethyl-4-morpholinothio)benzothiazole and dibenzothiazyl disulfide; guanidine compounds, such as diphenylguanidine (DPG), triphenylguanidine, diorthonitrileguanidine, orthonitrile biguanide and diphenylguanidine phthalate; aldehyde amine compounds or aldehyde ammonia compounds, such as acetaldehyde-aniline reaction product, butylaldehyde-aniline condensate, hexamethylenetetramine and acetaldehyde ammonia; imidazoline compounds, such as 2-mercaptoimidazoline; thiourea compounds, such as thiocarbanilide, diethylthiourea, dibutylthiourea, trimethylthiourea and diorthotolylthiourea; thiuram compounds, such as tetramethylthiuram monosulfide, tetramethylthiuram disulfide, tetraethylthiuram disulfide, tetrabutylthiuram disulfide and pentamethylenethiuram tetrasulfide; dithioate compounds, such as zinc dimethyldithiocarbamate, zinc diethyldithiocarbamate, zinc di-n-butyldithiocarbamate, zinc ethylphenyldithiocarbamate, zinc butylphenyldithiocarbamate, sodium dimethyldithiocarbamate, selenium dimethyldithiocarbamate and tellurium dimethyldithiocarbamate; xanthate compounds, such as zinc dibutylxanthogenate; and zinc components such as zinc oxide, zinc carbonate, and the other zinc compounds noted herein. In particular, the accelerate can include: N-ethyl-N-phenyldithiocarbamic acid zinc salt, 2-mercaptobenzothiazole, 2,2′-dibenzothiazole disulfide, tetramethyl thiuram monosulfide, tetrabenzylthiuram disulfide, and combinations thereof.

The crosslinking retarders can include, but are not limited to, alkoxyphenols, catechols, and benzoquinones, and alkoxyphenols such as 3,5-di-t-butyl-4-hydroxyanisol.

The weight percent for components of the composition (e.g., adhesive) can be: about 40 to 64 weight percent of the uncured or partially cured rubber, about 8 to 12 weight percent of the tackifying resin, about 20 to 44 weight percent of the filler, and 0 to 15 weight percent of one or more additional components.

The weight percent for components of the composition (e.g., adhesive) can be: about 40 to 64 weight percent of the uncured or partially cured rubber, about 1 to 1.4 weight percent of the polyether, about 8 to 12 weight percent of the tackifying resin, about 1.4 to 2 weight percent of the rubber curing agent and optionally one or more of the following: about 20 to 44 weight percent of the filler, about 2 to 2.6 weight percent of the zinc component, about 0.6 to 1 weight percent saturated fatty acid, about 0.1 to 1.4 weight percent accelerant, about 0.1 to 1.4 weight percent anti-fogging agent, and about 0.1 to 1 weight percent anti-aging agent.

The composition can be made by mixing the components described above in an oven at about 50 to 80 degrees Celsius. Once mixed, the composition (adhesive) can be used to form the uncured or partially cured foxing tape (or be applied to other uncured or partially cured rubber components). The uncured or partially cured foxing tape can be formed by applying (e.g., extruding, laminating, printing, pouring) the base foxing tape material (e.g., rubber) and the adhesive onto one another, where the uncured or partially cured foxing tape has a two layer structure. For example, the base foxing tape material (e.g., rubber) and the adhesive can be coextruded. In another example, the base foxing tape can be formed and the adhesive is printed, poured, or sprayed onto the base foxing tape. The first layer is a base foxing tape (e.g., uncured or partially cured) and the second layer is an uncrosslinked or partially crosslinked adhesive, where the first layer and second layer are disposed adjacent one another. In this regard, the uncrosslinked or partially crosslinked adhesive is in contact with the uncured or partially cured rubber on the second side of the base foxing tape.

The cured rubber foxing tape can be formed from the uncured or partially cured foxing tape by curing (e.g., in a vulcanization process). After curing, the base foxing tape comprises a cured rubber, where the crosslinked adhesive is bonded with the cured rubber on the second side of the base foxing tape. In addition, following curing, the cured foxing tape is secured (e.g., bonded) to the upper member and the cured shoe structure along the junction between the two.

The base foxing tape can be made of a rubber material as described herein in reference to the rubber in the composition. The crosslinked adhesive layer can have a thickness of about 0.1 to 5 millimeters or about 0.1-1.4 millimeters. The base foxing tape can have a thickness of about 0.1 to 10 millimeters or more or about 0.5 to 5 millimeters. The base foxing tape can have a width of about 1 to 150 millimeters or about 5 to 75 millimeters. The cured rubber foxing tape can have a thickness of about 0.2 to 15 millimeters or more or about 0.6 to 6 millimeters.

As used herein, the term “partially cured” generally refers to a compound (e.g., a rubber) having a relatively low crosslink density of less than or equal to 10⁻³ moles per cubic centimeter, or less than or equal to 10⁻⁵ moles per cubic centimeter. For example, the partially cured first or second composition can have from about 15 to about 1500 monomer units present between crosslinks. Dynamic mechanical analysis (DMA) can be used to determine the modulus plateau for the compound. In the region of the modulus plateau above the glass transition temperature of the compound and below the melting point of the compound, the crosslink density is directly proportional to the modulus of the compound. As used herein, the term “cured” generally refers to a compound (e.g., a rubber) having a relatively high crosslink density. For example, the crosslink density of the cured compound can be at least 20 percent greater, or at least 30 percent greater, or at least 50 percent greater than the crosslink density of the uncured or partially cured composition.

The term “partially cured” can denote the occurrence of at least about 1 percent, alternatively, at least about 5 percent of the total polymerization required to achieve a substantially full cure. The term “fully cured” is intended to mean a substantially full cure in which the degree of curing is such that the physical properties of the cured material do not noticeably change upon further exposure to conditions that induce curing (e.g., temperature, pressure, presence of curing agents, etc.).

The term “partially crosslinked” can denote the occurrence of at least about 1 percent, alternatively, at least about 5 percent of the total crosslinking required to achieve a substantially full crosslinking. The term “fully crosslinked” is intended to mean a substantially full crosslinking in which the degree of crosslinking is such that the physical properties of the crosslinked material do not noticeably change upon further exposure to conditions that induce crosslinking (e.g., temperature, pressure, presence of crosslinking agents, etc.).

In addition to rubber, the adhesive compositions, the base foxing tape, the rubber shoe structure, the material of the upper member, of any combination thereof, can comprise one or more additional polymers. The polymers described herein can be a thermoset polymer or a thermoplastic polymer (e.g., which are referred to in the adhesive, base foxing tape, and the like). The polymer can be an elastomeric polymer, including an elastomeric thermoset polymer or an elastomeric thermoplastic polymer. The polymer can be selected from: polyurethanes (including elastomeric polyurethanes, thermoplastic polyurethanes (TPUs), and elastomeric TPUs), polyesters, polyethers, polyamides, vinyl polymers (e.g., copolymers of vinyl alcohol, vinyl esters, ethylene, acrylates, methacrylates, styrene, and so on), polyacrylonitriles, polyphenylene ethers, polycarbonates, polyureas, polystyrenes, co-polymers thereof (including polyester-polyurethanes, polyether-polyurethanes, polycarbonate-polyurethanes, polyether block polyamides (PEBAs), and styrene block copolymers), and any combination thereof, as described herein. The polymer can include one or more polymers selected from the group consisting of polyesters, polyethers, polyamides, polyurethanes, polyolefins copolymers of each, and combinations thereof.

The term “polymer” refers to a chemical compound formed of a plurality of repeating structural units referred to as monomers. Polymers often are formed by a polymerization reaction in which the plurality of structural units become covalently bonded together. When the monomer units forming the polymer all have the same chemical structure, the polymer is a homopolymer. When the polymer includes two or more monomer units having different chemical structures, the polymer is a copolymer. One example of a type of copolymer is a terpolymer, which includes three different types of monomer units. The co-polymer can include two or more different monomers randomly distributed in the polymer (e.g., a random co-polymer). Alternatively, one or more blocks containing a plurality of a first type of monomer can be bonded to one or more blocks containing a plurality of a second type of monomer, forming a block copolymer. A single monomer unit can include one or more different chemical functional groups.

The composition may further comprise, consist of, or consist essentially of one or more processing aids not previously described. These processing aids may be independently selected from the group including, but not limited to, initiators, plasticizers, mold release agents, lubricants, antioxidants, flame retardants, dyes, pigments, reinforcing and non-reinforcing fillers, fiber reinforcements, and light stabilizers.

### EXAMPLES

### Example 1

An example of the uncured or partially cured foxing tape includes the adhesive having a thickness of about 0.1-1.2 mm. The adhesive has the following parts by weight: natural rubber 42 parts, silica 16 parts, nano-calcium and active calcium carbonate 30 parts, polyethylene glycol 1.2 parts, zinc carbonate 2 parts, anti-aging agent SP 0.9 part, tackifying resin (C5 petroleum resin) 8.4 parts, active agent RX-87 0.5 part, stearic acid 0.45 part, sulfur 1.05 parts, and accelerant (PX powder) 1.05 parts.

The uncured or partially cured foxing tape is produced by the following method:

(1) The adhesive is prepared by mixing and blending all of the ingredients listed above according to the aforementioned ratios;

(2) The material of the base foxing tape is compounded, water cooled and cut;

(3) The adhesive and base foxing tape are coextruded from an extruder; and

(4) Optionally, a release liner such as a release fabric may be used among the layers of uncured or partially cured foxing tape so that the uncured or partially cured foxing tape can be stacked for storage.

### Example 2

An example of the uncured or partially cured foxing tape includes the adhesive having a thickness of about 0.1-1.2 mm. The adhesive has the following parts by weight: a mixture of natural rubber and synthetic rubber 50 parts, silica 30 parts, nano-calcium 35 parts, polyethylene glycol 2 parts, zinc oxide 4 parts, anti-aging agent SP 1.5 parts, tackifying resin (C9 petroleum resin) 15 parts, active agent RX-87 1 part, stearic acid 1 part, sulfur 2 parts, and accelerant (accelerant M) 2 parts.

The uncured or partially cured foxing tape is produced by the following method:

(1) The adhesive is prepared by mixing and blending all of the ingredients listed above according to the aforementioned ratios;

(2) The material of the base foxing tape is compounded, water cooled and cut;

(3) The adhesive and base foxing tape are coextruded from an extruder; and

(4) Optionally, a release liner such as a release fabric may be used among the layers of uncured or partially cured foxing tape so that the uncured or partially cured foxing tape can be stacked for storage.

### Example 3

An example of the uncured or partially cured foxing tape includes the adhesive having a thickness of about 0.1-1.2 mm. The adhesive has the following parts by weight: natural rubber 30 parts, silica 5 parts, active calcium carbonate 5 parts, polyethylene glycol 0.5 part, zinc carbonate 1 part, anti-aging agent SP 0.1 part, tackifying resin (terpene phenolic resin) 5 parts, active agent RX-87 0.1 part, stearic acid 0.1 part, sulfur 0.5 part, and accelerant (accelerant TBZTD) 0.5 part.

The uncured or partially cured foxing tape is produced by the following method:

(1) The adhesive is prepared by mixing and blending all of the ingredients listed above according to the aforementioned ratios;

(2) The material of the base foxing tape is compounded, water cooled and cut;

(3) The adhesive and base foxing tape are coextruded from an extruder; and (4) Optionally, a release liner such as a release fabric may be used among the layers of uncured or partially cured foxing tape so that the uncured or partially cured foxing tape can be stacked for storage.

Prior to the application of the uncured or partially cured foxing tape to the upper member or the sole structure (e.g., a rubber component such as those described herein), the adhesive can be activated by heating at least the adhesive layer of the uncured or partially cured foxing tape to a temperature of 60-70 degrees Celsius. Following activation of the adhesive of the foxing tape, the adhesive is contacted with the upper member or the sole structure of both. Optionally, prior to contacting the upper member or the sole structure with the activated foxing tape, treating agent or adhesive or both can be applied to the upper member or the sole structure or both. After contacting the adhesive of the foxing tape and the upper member or sole structure or both, pressure is applied to the foxing tape and the upper member or sole structure or both. Following or during the application of pressure, actinic radiation is applied to the combination of the foxing tape and the upper member or sole structure or both, curing the rubber of the foxing tape, the rubber sole structure, the adhesive, or any combination thereof, bonding the components (foxing tape, upper member, sole structure, adhesive, and combinations thereof) to each other.

The test method of the bonding performance of cured rubber articles of footwear produced with cured foxing tapes of Examples 1-3 is: 24 hours after curing (e.g., vulcanization), pull test, at the standard of 3.0 kg/cm; 24 hours after curing, bend test at 60 degrees, with the standard of over 70,000 times. A cured rubber article of footwear manufactured using conventional foxing tape and conventional adhesives and treating agents was used as the control. This process included treating an uncured foxing tape with a treating agent, drying the treating agent, applying a water-borne adhesive including a solvent, and then drying the adhesive. The upper member and sole structure were also prepared with the treating agent, the treating agent was dried, the water-borne adhesive including a solvent was applied, and then the adhesive was dried. The conventionally prepared foxing tape, upper member, and sole structure were then brought together, pressure was applied, and then were exposed to actinic radiation to cure the rubber of the foxing tape and sole structure, bonding the upper member and sole structure together and forming the cured rubber article of footwear The specific test results are shown in Table 1 below

TABLE 1
Bonding performance of cured rubber articles of footwear produced with foxing
tapes of Example 1-3 as well as conventional foxing tapes and adhesives

| | | | | | | | | Bend 60° * | |
|---|---|---|---|---|---|---|---|---|---|
| | | | | | | | | 100 HZ * 16 | |
| | | | | | | | | | Average |
| | | | | | | | | | (Number |
| | | Pull of foxing tape and upper | | | Pull of foxing tape and sole | | | Over | of bends |
| | | | Average | | | Average | | 70,000 | when an |
| | Foxing | Pull | pull | Actual | Pull | pull | Actual | times | opening |
| Test No. | tape type | (kg/cm) | (kg/cm) | damage | (kg/cm) | (kg/cm) | damage | (each) | appears) |
| Ex. 1 | Foxing | 3.5-5.0 | 4.1 | Coextruded | 5.4-6.4 | 5.8 | Sole | 15 | 100,000 |
| | tape from | | | adhesive | | | damaged | | |
| | Example 1 | | | damaged | | | | | |
| Ex. 2 | Foxing | 3.8-5.7 | 4.5 | Upper | 5.6-6.8 | 6.3 | Sole | 16 | 100,000 |
| | tape from | | | damaged | | | damaged | | |
| | Example 2 | | | | | | | | |
| Ex. 3 | Foxing | 3.5-4.5 | 4.0 | Upper | 4.5-5.5 | 5.1 | Foxing | 13 | 85,000 |
| | tape from | | | damaged | | | tape | | |
| | Example 3 | | | | | | damaged | | |
| Control | Traditional | 3.2-4.0 | 3.7 | Adhesive | 3.9-4.6 | 4.2 | Sole | 10 | 80,000 |
| group | foxing | | | damaged | | | damaged | | |
| | tape and | | | | | | | | |
| | Traditional | | | | | | | | |
| | Adhesive | | | | | | | | |

As shown in Table 1, the bonding performance of cured rubber articles of footwear produced with foxing tapes and methods of the present disclosure is comparable or superior to that of cured rubber articles of footwear produced with the traditional materials and method.

### Example 4

An example of the uncured or partially cured foxing tape includes the adhesive having a thickness of about 0.1-1.2 mm. The adhesive has the following parts by weight: natural rubber 100 parts, silica 45 parts, calcium carbonate 30 parts, polyethylene glycol 4.5 parts, zinc carbonate 4.76 parts, anti-aging agent SP 2.4 parts, tackifying resin (C5 petroleum resin) 20 parts, active agent RX-87 1.2 parts, stearic acid 1 part, sulfur 1.7 parts, and accelerant (PX powder) 1.6 parts.

The cured foxing tape is produced by the following method:

(1) The adhesive is prepared by mixing and blending all of the ingredients listed above according to the aforementioned ratios;

(2) The material of the base foxing tape is compounded, water cooled and cut;

(3) The adhesive and base foxing tape are coextruded from an extruder; and

(4) Optionally, a release liner such as a release fabric may be used among the layers of uncured or partially cured foxing tape so that the uncured or partially cured foxing tape can be stacked for storage.

The present disclosure is also described in the following clauses.

Clause 1. A composition comprising:

an uncured or partially cured rubber;

a tackifying resin; and optionally,

a filler.

Clause 2. The composition of clause 1, wherein the weight percent for components of the composition are as follows: about 40 to 64 weight percent of the uncured or partially cured rubber, about 8 to 12 weight percent of the tackifying resin, about 20 to 44 weight percent of the filler, and 0 to 15 weight percent of one or more additional components.
Clause 3. The composition of any preceding clause, wherein the composition is substantially free of organic compounds that become volatilized when heated to a temperature of 60 degrees Celsius or above at about 1 ATM.
Clause 4. The composition of clause 3, wherein the organic compounds comprise acetone, methyl ethyl ketone, ethyl acetate, or a combination thereof.
Clause 5. The composition of any preceding clause, wherein the composition is an uncrosslinked or partially crosslinked adhesive configured for bonding to or between uncured or partially cured rubber in a rubber curing process.
Clause 6. The composition of any preceding clause, wherein the uncured or partially cured rubber is a natural rubber, synthetic rubber, or a mixture of the natural rubber and the synthetic rubber, optionally wherein the uncured or partially cured rubber is a natural rubber.
Clause 7. The composition of any preceding clause, wherein the tackifying resin is selected from a hydrocarbon resin, a terpene resin, or a combination thereof.
Clause 8. The composition of clause 9, wherein the hydrocarbon resin is an aliphatic hydrocarbon resin, or an aromatic hydrocarbon resin, optionally wherein the hydrocarbon resin is an aromatic hydrocarbon resin.
Clause 9. The composition of clause 9, wherein the terpene resin is selected from a terpene phenolic resin, a polyterpene resin, a styrenated terpene resin, or a combination thereof.
Clause 10. The composition of any preceding clause, wherein the filler comprises a silica, a calcium component, or a combination thereof, optionally wherein the filler is silica, and optionally wherein the calcium component comprises a nano-calcium, a calcium carbonate, or a combination thereof.
Clause 11. The composition of any preceding clause, wherein the composition is a solid at temperatures below 55 degrees Celsius, and a liquid or semi-solid at temperatures above 60 degrees Celsius.
Clause 12. The composition of any preceding clause, wherein the composition further comprises a polyether, a rubber curing agent, or both.
Clause 13. The composition of any preceding clause, wherein the uncured or partially cured rubber is at least partially soluble in the polyether.
Clause 14. The composition of any preceding clause, wherein the polyether is selected from a polyethylene glycol or a polypropylene glycol.
Clause 15. The composition of any preceding clause, wherein the rubber curing agent comprises sulfur component or a peroxide or both.
Clause 16. The composition of clause 15, wherein the sulfur component is selected from elemental sulfur or a sulfur-containing organic compound.
Clause 17. The composition of any preceding clause, wherein the sulfur-containing organic compound is a monosulfide compound, a disulfide compound, or a polysulfide compound.
Clause 18. The composition of any preceding clause, wherein the rubber curing agent further comprises zinc oxide, an accelerant, or both.
Clause 19. The composition of clause 18, wherein the zinc component comprises zinc carbonate, zinc oxide, or a combination thereof.
Clause 20. The composition of clause 18, wherein the accelerant is selected from: N-ethyl-N-phenyldithiocarbamic acid zinc salt, 2-mercaptobenzothiazole, 2,2′-dibenzothiazole disulfide, tetramethyl thiuram monosulfide, or tetrabenzylthiuram disulfide.
Clause 21. The composition of any preceding clause, wherein the weight percent for components of the composition are as follows: about 40 to 64 weight percent of the uncured or partially cured rubber, about 8 to 12 weight percent of the tackifying resin, about 20 to 44 weight percent of the filler, about 1 to 1.4 weight percent of the polyether, about 1.4 to 2 weight percent of the rubber curing agent and 0 to 10 weight percent of one or more additional components.
Clause 22. The composition of any preceding clause, wherein the composition further comprises a fatty acid, optionally wherein the fatty acid is a saturated fatty acid, and optionally wherein the saturated stearic acid is stearic acid.
Clause 23. The composition of any preceding clause, wherein the composition further comprises an anti-oxidant agent, an anti-fogging agent, or both.
Clause 24. The composition of claim 23, wherein the anti-oxidant agent comprises styrene phenol.
Clause 25. The composition of clause 24, wherein the anti-fogging agent is sorbitan ester.
Clause 26. The composition of any preceding clause, wherein the weight percent for components of the composition are as follows: about 40 to 64 weight percent of the uncured or partially cured rubber, about 1 to 1.4 weight percent of the polyether, about 8 to 12 weight percent of the tackifying resin, about 1.4 to 2 weight percent of the rubber curing agent and optionally one or more of the following: about 20 to 44 weight percent of the filler, about 2 to 2.6 weight percent of the zinc component, about 0.6 to 1 weight percent saturated fatty acid, about 0.1 to 1.4 weight percent accelerant, about 0.1 to 1.4 weight percent anti-fogging agent, and about 0.1 to 1 weight percent anti-aging agent.
Clause 27. An uncured or partially cured foxing tape, comprising: a two-layer structure of a base foxing tape and an uncrosslinked or partially crosslinked adhesive, wherein the base foxing tape comprises an uncured or partially cured rubber, wherein the uncured or partially cured foxing tape has a first side and a second side opposite the first side, wherein the uncrosslinked or partially crosslinked adhesive is in contact with the uncured or partially cured rubber on the second side of the uncured or partially cured foxing tape, wherein the uncrosslinked or partially crosslinked adhesive comprises: a composition according to any of clauses 1 to 26.
Clause 27. The uncured or partially cured foxing tape of clause 26, wherein the uncured or partially cured foxing tape further comprises a release material disposed on the first side of the uncured or partially cured foxing tape.
Clause 28. The uncured or partially cured foxing tape of clause 27, wherein the release material comprises a polymer film, a textile, or both.
Clause 29. The uncured or partially cured foxing tape of any preceding clause, wherein the crosslinked adhesive layer has a thickness of about 0.1-1.5 millimeters.
Clause 30. The uncured or partially cured foxing tape of any preceding clause, wherein the base foxing tape has a thickness of about 0.5 to 5 millimeters, optionally wherein the base foxing tape has a width of about 5 to 75 mm millimeters or optionally wherein the cured rubber foxing tape has a thickness of about 0.6 to 6 millimeters.
Clause 31. The uncured or partially cured foxing tape of any preceding clause, wherein the base foxing tape and the uncrosslinked or partially crosslinked adhesive comprise at least about 7 weight percent of a natural rubber.
Clause 32. The uncured or partially cured foxing tape of any preceding clause, wherein the uncrosslinked or partially crosslinked adhesive is about 5 to 10 weight percent of the uncured or partially cured foxing tape.
Clause 33. An article of footwear, comprising: an upper, wherein at the point of contact between the upper and a cured rubber shoe structure on the outer edge perimeter of the footwear is a junction, wherein a cured rubber foxing tape is disposed on at least a first part of the upper and the cured rubber shoe structure along the junction, wherein the cured rubber foxing tape has a two-layer structure of a base foxing tape and a crosslinked adhesive, wherein the base foxing tape has a first side and a second side opposite the first side, wherein the first side is outwardly facing, wherein the crosslinked adhesive is on the second side of the base foxing tape, wherein the crosslinked adhesive is adjacent the upper, the cured rubber shoe structure, and the junction, and wherein the cured rubber foxing tape is bonded to the cured rubber shoe structure, the upper, or both by the crosslinked adhesive, wherein the crosslinked adhesive is the cured reaction product of a composition according to any of clauses 1 to 26.
Clause 34. The article of clause 33, wherein the cured rubber foxing tape is bonded to the first part of the upper and the cured rubber shoe structure along the junction, wherein the first part is in the toe region, optionally wherein the first part is a toe cap, a bumper, or both.
Clause 35. The article of clause 33, wherein the cured rubber foxing tape is bonded to the first part and a second part of the upper and the cured rubber shoe structure along the junction, wherein the first part is in the toe region and the second part in the heel region, optionally wherein the second part comprises a heel logo.
Clause 36. The article of clause 33, wherein the cured rubber foxing tape is bonded around the entire perimeter of the upper and the cured rubber shoe structure along the junction.
Clause 37. The article of any preceding clause, wherein the base foxing tape is a cured foxing tape and wherein the cured foxing tape comprises cured rubber, optionally wherein the cured rubber is cured natural rubber.
Clause 38. The article of any preceding clause, further comprises one or more of the following: wherein the crosslinked adhesive layer has a thickness of about 0.1-1.2 millimeters, wherein the base foxing tape has a thickness of about 0.5 to 5 millimeters, wherein the base foxing tape has a width of about 5 to 75 mm millimeters, or wherein the cured rubber foxing tape has a thickness of about 0.6 to 6 millimeters.
Clause 39. A method of making an article of footwear, comprising:

activating the uncured or partially cured foxing tape of clause 27 to 32;

disposing, at a junction at the point of contact between an upper member and an uncured or partially cured shoe structure, the uncured or partially cured foxing tape on a first part of the perimeter of the footwear on the junction so that the uncured or partially cured foxing tape is disposed on a first part of the upper member and on a first part of the uncured or partially cured shoe structure along the junction, wherein a portion of the uncured or partially cured foxing tape comprising the adhesive is adjacent a first part of the upper member, a first part of the uncured or partially cured shoe structure, and the junction; and

curing the article to form a cured rubber shoe including cured rubber foxing tape and a cured rubber shoe structure, wherein the cured rubber shoe structure and upper member are bonded together at least in part by crosslinks formed between the cured rubber of the foxing tape and the cured rubber of the shoe structure.

Clause 40. The method of clause 39, wherein activating, disposing, or both are substantially free of organic compounds that become volatilized.
Clause 41. The method of clause 40, wherein the organic compounds comprise acetone, methyl ethyl ketone, ethyl acetate, or a combination thereof.
Clause 42. The method of clause 39, wherein curing comprises heating the article to about 100 to 140 degrees Celsius, or optionally about 120 degrees Celsius, and optional for about 50 to 120 minutes.
Clause 43. The method of any preceding clause, wherein activating comprises heating the uncured or partially cured foxing tape to about 55 to 60 degrees Celsius.
Clause 44. The method of any preceding clause, wherein the first part of the upper member does not include an adhesive or cement on the surface to which the uncured or partially cured foxing tape is disposed and wherein the first part of the uncured or partially cured shoe structure does not include an adhesive or cement on the surface to which the uncured or partially cured faxing tape is disposed.
Clause 45. The method of any preceding clause, wherein the first part of the upper member, the first part of the uncured or partially cured shoe structure, and the uncured or partially cured foxing tape is not primed prior to disposing the uncured or partially cured foxing tape on the first part of the upper member and the first part of the uncured or partially cured shoe structure, optionally wherein not priming the uncured or partially cured foxing tape includes not using acetone, methyl ethyl ketone, ethyl acetate, or a combination thereof during activating the uncured or partially cured foxing tape.
Clause 46. An article of footwear made using the method of any one of clauses 39 to 45.
Clause 47. A method of making an uncured or partially cured foxing tape, comprising:

applying a layer of an uncured or partially cured adhesive to a base foxing tape material to form an uncured or partially cured foxing tape having a two layer structure, wherein the first layer of the uncured or partially cured foxing tape is a base foxing tape comprising an uncured or partially cured rubber and the second layer is an uncrosslinked or partially crosslinked adhesive composition according to any one of clauses 1 to 26, wherein the first layer and second layer are disposed adjacent one another.

Clause 48. The method of clause 47, wherein applying includes coextruding the uncured or partially cured adhesive to the base foxing tape material to form an uncured or partially cured foxing tape.
Clause 49. The method of clause 47, wherein applying includes laminating the uncured or partially cured adhesive to the base foxing tape material to form an uncured or partially cured foxing tape.
Clause 50. The method of clause 47, further comprising forming the base foxing tape from the base foxing tape material and wherein applying includes spraying, printing, or pouring, the uncured or partially cured adhesive on to the base foxing tape.
Clause 51. The method of any preceding clause, further comprising mixing components to form the uncured or partially cured adhesive, wherein the components are according to any one composition clauses 1 to 26.
Clause 52. The method of any preceding clause, further comprising applying the release material to the first layer, the second layer, or both.
Clause 53. The method of clause 52, wherein the release material comprises a polymer film or a textile or both.
Clause 54. The method of any preceding clause, further comprises one or more of the following: wherein the second layer has a thickness of about 0.1-1.2 millimeters, wherein the first layer has a thickness of about 0.5 to 5 millimeters, wherein the uncured or partially cured foxing tape has a width of about 5 to 75 mm millimeters, or wherein the uncured or partially cured foxing tape has a thickness of about 0.6 to 6 millimeters.
Clause 55. An uncured or partially cured rubber component, comprising: an uncrosslinked or partially crosslinked adhesive on a surface of the uncured or partially cured rubber component, wherein the uncured or partially cured rubber component comprises an uncured or partially cured rubber, wherein the uncrosslinked or partially crosslinked adhesive is in contact with the uncured or partially cured rubber of the uncured or partially cured rubber component, wherein the uncrosslinked or partially crosslinked adhesive comprises: a composition according to any of clauses 1 to 26.
Clause 56. The uncured or partially cured rubber component of clause 55, wherein the uncured or partially cured rubber component includes a foxing tape, a toe cap, a bumper, a heel logo, a cup sole, midsole, or an outsole.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1 percent to about 5 percent” should be interpreted to include not only the explicitly recited concentration of about 0.1 wt percent to about 5 wt percent, but also include individual concentrations (e.g., 1 percent, 2 percent, 3 percent, and 4 percent) and the sub-ranges (e.g., 0.5 percent, 1.1 percent, 2.2 percent, 3.3 percent, and 4.4 percent) within the indicated range. In an aspect, the term “about” can include traditional rounding according to significant figures of the numerical value. In addition, the phrase “about ‘x’ to ‘y’” includes “about ‘x’ to about ‘y’”.

Many variations and modifications may be made to the above-described aspects. All such modifications and variations are intended to be included herein within the scope of this disclosure and protected by the following claims.

1. An uncured or partially cured foxing tape, comprising: a two-layer structure of a base foxing tape and an uncrosslinked or partially crosslinked adhesive, wherein the base foxing tape comprises an uncured or partially cured rubber, wherein the uncured or partially cured foxing tape has a first side and a second side opposite the first side, wherein the uncrosslinked or partially crosslinked adhesive is in contact with the uncured or partially cured rubber on the second side of the uncured or partially cured foxing tape, wherein the uncrosslinked or partially crosslinked adhesive comprises:
an uncured or partially cured rubber;
a tackifying resin; and
a filler.

2. The uncured or partially cured foxing tape of claim 1, wherein the weight percent for components of the uncrosslinked or partially crosslinked adhesive are as follows: about 40 to 64 weight percent of the uncured or partially cured rubber, about 8 to 12 weight percent of the tackifying resin, about 20 to 44 weight percent of the filler and 0 to 15 weight percent of one or more additional components.

3. The uncured or partially cured foxing tape of claim 1, wherein the adhesive is substantially free of organic compounds that become volatilized when heated to a temperature of 60 degrees Celsius or above at about 1 ATM.

4. The uncured or partially cured foxing tape of claim 2, wherein the organic compounds comprise acetone, methyl ethyl ketone, ethyl acetate, or a combination thereof.

5. The uncured or partially cured foxing tape of claim 1, wherein the uncured or partially cured rubber is a natural rubber, a synthetic rubber, or a mixture of the natural rubber and the synthetic rubber.

6. The uncured or partially cured foxing tape of claim 5, wherein the uncured or partially cured rubber is a natural rubber.

7. The uncured or partially cured foxing tape of any one of claim 1, wherein the tackifying resin is selected from a hydrocarbon resin, a terpene resin, or a combination thereof.

8. The uncured or partially cured foxing tape of claim 7, wherein the hydrocarbon resin is an aromatic hydrocarbon resin.

9. The uncured or partially cured foxing tape of any one of claim 1, wherein the filler is silica.

10. The uncured or partially cured foxing tape of claim 9, further comprising a rubber curing agent that comprises a sulfur component, wherein the sulfur component is selected from elemental sulfur or a sulfur-containing organic compound.

11. A method of making an article of footwear, comprising:
activating the uncured or partially cured foxing tape, wherein the uncured or partially cured foxing tape is a two-layer structure of a base foxing tape and an uncrosslinked or partially crosslinked adhesive, wherein the base foxing tape comprises an uncured or partially cured rubber, wherein the uncured or partially cured foxing tape has a first side and a second side opposite the first side, wherein the uncrosslinked or partially crosslinked adhesive is in contact with the uncured or partially cured rubber on the second side of the uncured or partially cured foxing tape, wherein the uncrosslinked or partially crosslinked
adhesive comprises:
an uncured or partially cured rubber;
a tackifying resin; and
a filler;
disposing, at a junction at the point of contact between an upper member and an uncured or partially cured shoe structure, the uncured or partially cured foxing tape on a first part of the perimeter of the footwear on the junction so that the uncured or partially cured foxing tape is disposed on a first part of the upper member and on a first part of the uncured or partially cured shoe structure along the junction, wherein a portion of the uncured or partially cured foxing tape comprising the adhesive is adjacent a first part of the upper member, a first part of the uncured or partially cured shoe structure, and the junction; and curing the article to form a cured rubber shoe including the cured rubber foxing tape and a cured rubber shoe structure, wherein the cured rubber sole structure and upper member are bonded together at least in part by crosslinks formed between the cured rubber of the foxing tape and the cured rubber of the shoe structure.

12. The method of claim 11, wherein the weight percent for components of the uncrosslinked or partially crosslinked adhesive are as follows: about 40 to 64 weight percent of the uncured or partially cured rubber, about 8 to 12 weight percent of the tackifying resin, about 20 to 44 weight percent of the filler and 0 to 15 weight percent of one or more additional components.

13. The method of claim 11, wherein activating, disposing, curing, or a combination thereof are substantially free of organic compounds that become volatilized.

14. The method of claim 13, wherein the organic compounds comprise acetone, methyl ethyl ketone, ethyl acetate, or a combination thereof.

15. The method of any one of claim 11, wherein curing comprises heating the article to about 100 to 140 degrees Celsius and optionally for about 50 to 120 minutes.

16. The method of claim 12, wherein activating comprises heating the uncured or partially cured foxing tape to about 55 to 60 degrees Celsius.

17. The method of any one of claim 11, wherein the first part of the upper member, the first part of the uncured or partially cured shoe structure, and the uncured or partially cured foxing tape is not primed prior to disposing the uncured or partially cured foxing tape on the first part of the upper member and the first part of the uncured or partially cured shoe structure, optionally wherein not priming the uncured or partially cured foxing tape includes not using acetone, methyl ethyl ketone, ethyl acetate, or a combination thereof during activating the uncured or partially cured foxing tape.

18. The method of any one of claim 11, wherein prior to disposing the uncured or partially cured foxing tape, the first part of the upper member does not include an adhesive on the surface to which the uncured or partially cured foxing tape is disposed and wherein the first part of the uncured or partially cured shoe structure does not include an adhesive on the surface to which the uncured or partially cured foxing tape is disposed.

19. The method of any one of claim 11, wherein the upper member, uncured or partially cured foxing tape, uncured or partially cured shoe structure, and the uncrosslinked or partially crosslinked adhesive each comprises about 7 weight percent or more of a natural rubber.

20. An article of footwear made using the method of claim 11.
